(19) United States
(12) Patent Application Publication
(10) Pub. No.: US 2026/0295639 A1
(43) Pub. Date: Oct. 1, 2026

(54) MULTI-CHANNEL SORTING MACHINE FOR PARCEL SINGULATION

(71) Applicant: WAYZIM TECHNOLOGY CO., LTD., Jiangsu (CN)

(72) Inventors: Qingsheng OUYANG, Jiangsu (CN); Ye CAI, Jiangsu (CN); Hao RUI, Jiangsu (CN)

(73) Assignee: WAYZIM TECHNOLOGY CO., LTD., Jiangsu (CN)

(21) Appl. No.: 19/480,353

(22) PCT Filed: May 23, 2023
(86) PCT No.: PCT/CN2023/095805

§ 371 Date: Oct. 30, 2025

(30) Foreign Application Priority Data
May 18, 2023 (CN) 202310563084.9

(51) Int. Cl. B07C 3/08; B07C 1/04; B07C 1/18; B07C 3/14

(52) U.S. Cl. CPC B07C 3/08; B07C 1/04; B07C 1/18; B07C 3/14

(57) ABSTRACT

A multi-channel sorting machine includes a feeding mechanism, parcel separation channels, a roller centering machine, and a dragsaw belt conveyor. Each of the parcel separation channels includes a multi-channel stack separation mechanism and a multi-channel parcel singulation mechanism. In the process of conveying parcels by an inclined conveyor belt, the inclined conveyor belt suddenly accelerates and then suddenly decelerates, so that misalignment is caused between two stacked parcels by means of acceleration relying on inertia. Then a visual identification system of a previous stack separation unit identifies the misalignment of the parcels according to overlapping conditions of the parcels conveyed by the current stack separation unit, a maximum speed of the inclined conveyor belt of a next stack separation unit is controlled to further separate vertically stacked parcels, and when the vertically stacked parcels are separated, no change in the speed of the inclined conveyor belt is made.

### TECHNICAL FIELD

The present disclosure relates to the technical field of logistics sorting equipment, and in particular to a multi-channel sorting machine for parcel singulation.

### TECHNICAL BACKGROUND

The development of the transportation industry and industrial decentralization necessitate the circulation of industrial and civilian goods between different regions, which further leads to the booming development of the logistics industry. For example, in the logistics-based industries such as logistics distribution centers of civil aviation companies, postal services, express delivery, tobacco, and beer industries, different batches of products and different products are circulated to different destinations, product sorting is required in the final logistics distribution process, and parcel sorting becomes particularly important in the logistics industry.

As logistics sorting is increasingly automated, various devices have been developed to achieve unmanned sorting. During the logistics sorting process, many parcels are stacked, which is unfavorable for sorting.

### SUMMARY OF THE INVENTION

### Technical Problems

In the prior art, a standard sorting machine usually includes an input belt conveyor, a stack separation zone, a parcel singulation zone, a centering machine, and a distance-increasing belt conveyor. Each machine may be used as an independent modular device configured to perform specified functions, and stack separation is usually implemented by means of a shift lever or an inclined conveyor belt with gravity. However, the above two separation methods are limited in application scenarios, and are ineffective in separation of parcels of various sizes with high friction. Additionally, sorting machines of the prior art mostly operate in a single-channel mode, which results in low separation efficiency, wide idle areas, and a low channel utilization rate. Currently, no effective solutions have been offered to solve the problems in the related art so far.

### Technical Solutions

A multi-channel sorting machine for parcel singulation includes: a feeding mechanism, parcel separation channels, a roller centering machine, and a dragsaw belt conveyor; parcels are fed into the parcel separation channels through the feeding mechanism for separation, then centered, corrected, and aligned by the roller centering machine, and finally fed onto the dragsaw belt conveyor for conveying at a certain spacing therebetween; the number of the parcel separation channels is at least two, all the parcel separation channels are arranged side by side, and a partition is disposed between every two adjacent parcel separation channels; widths of the feeding mechanism, the roller centering machine, and the dragsaw belt conveyor are all adapted to a total width of all the parcel separation channels arranged side by side; each of the parcel separation channels includes a multi-channel stack separation mechanism and a multi-channel parcel singulation mechanism, each of the multi-channel stack separation mechanisms includes a plurality of stack separation channels, each of the multi-channel parcel singulation mechanisms includes a plurality of parcel singulation channels, and for each of the parcel separation channels, the number of the stack separation channels is equal to the number of the parcel singulation channels; each of the stack separation channels includes a plurality of stack separation units and a transfer unit, the plurality of the stack separation units are connected end to end sequentially, and the transfer unit is configured to transfer the parcels conveyed from the last stack separation unit to the parcel singulation channel corresponding to the stack separation channel; each of the stack separation units includes an inclined conveyor belt, a horizontal conveyor belt, and a visual identification system; and the visual identification system identifies whether parcels overlap with each other, and the visual identification system of the previous stack separation unit controls a maximum speed of the inclined conveyor belt of the next stack separation unit according to overlapping conditions of the parcels conveyed by the current stack separation unit.

Preferably, in the i^{th} stack separation unit, the inclined conveyor belt has an initial speed of V0, and the inclined conveyor belt has a maximum speed of Vi; and the speed of the inclined conveyor belt suddenly accelerates from V0 to Vi, and then suddenly decelerates from Vi to V0, to separate the stacked parcels conveyed in the i^{th} stack separation unit.

Preferably, when the speed of the inclined conveyor belt in the i^{th} stack separation unit is V0, the visual identification system identifies an area of parcels on a conveying surface of the current inclined conveyor belt, and calculates a percentage Wi % of the area of parcels to an area of the conveying surface of the inclined conveyor belt; and Wi of the parcels conveyed by the i^{th} stack separation unit is compared with Wi+1 of the parcels conveyed by the i+1^{th} stack separation unit to determine a stacking status of the parcels conveyed by the i+1^{th} stack separation unit.

Preferably, when Wi+1=2 Wi, it is determined that parcels are stacked in the i^{th} stack separation unit, but the stacked parcels are completely separated in the i+1^{th} stack separation unit; when Wi+1=Wi, it is determined that no parcels are stacked in the i^{th} stack separation unit; and when Wi<Wi+1<2 Wi, it is determined that parcels are stacked in the i^{th} stack separation unit, and the stacked parcels are still stacked in the i+1^{th} stack separation unit.

Preferably, when Wi+1=2 Wi and Wi+1=Wi, that is, when no parcels are stacked in the i+1^{th} stack separation unit, a maximum speed Vi+1 of the inclined conveyor belt in the i+1^{th} stack separation unit is equal to Vi.

Preferably, when Wi<Wi+1<2 Wi, that is, when parcels are stacked in the i^{th} stack separation unit and the stacked parcels are still stacked in the i+1^{th} stack separation unit: The maximum speed Vi+1 of the inclined conveyor belt in the i+1^{th} stack separation unit is greater than or equal to Vi.

Preferably, when Wi<Wi+1<2 Wi, that is, when parcels are stacked in the i^{th} stack separation unit and the stacked parcels are still stacked in the i+1^{th} stack separation unit: A parcel stacking difference ratio Xi+1 between the i+1^{th} stack separation unit and the i^{th} stack separation unit is calculated, where Xi+1=(Wi+1−Wi)/W1; when Xi+1≥0.5, the maximum speed Vi+1 of the inclined conveyor belt in the i+1^{th} stack separation unit is equal to Vi; and when Xi+1<0.5, the maximum speed Vi+1 of the inclined conveyor belt in the i+1^{th} stack separation unit is equal to 1.2 Vi.

Preferably, each of the parcel singulation channels includes a plurality of parcel singulation units and a single-parcel visual system, where a conveying speed of each of the parcel singulation units may be set separately, and the single-parcel visual system is configured to identify parcel classification information and control the conveying speed of each of the parcel singulation units respectively, so as to arrange the parcels in an orderly manner.

Preferably, each of the parcel singulation units includes a transmission belt, side guard plates, a drive roller, a timing pulley, and a synchronous belt; and the side guard plates are disposed on both sides of the transmission belt, a servo motor is disposed in either of the two side guard plates, an output shaft of the servo motor outputs power to the timing pulley through the synchronous belt, rotation of the timing pulley is transmitted to the drive roller coaxial with the timing pulley, and the drive roller drives the transmission belt to rotate.

### Beneficial Effects

Compared with the prior art, the present disclosure provides a multi-channel sorting machine for parcel singulation, and has the following beneficial effects:
1. For the multi-channel sorting machine for parcel singulation, different numbers of the feeding mechanisms, the parcel separation channels, the roller centering machines, and the dragsaw belt conveyors are combined, and a plurality of channels are arranged in the parcel separation channels to meet multi-purpose requirements, and the multi-channel design reduces idle areas on both sides of each of the channels, improves the utilization efficiency of an equivalent area, and effectively improves the parcel processing efficiency of the entire multi-channel sorting machine for parcel singulation.
2. For the multi-channel sorting machine for parcel singulation, in each of the stack separation units, parcels first enter the inclined conveyor belt, and in the process of conveying by the inclined conveyor belt, the visual identification system identifies whether parcels overlap with each other, and the visual identification system of the previous stack separation unit controls a maximum speed of the inclined conveyor belt of the next stack separation unit according to overlapping conditions of the parcels conveyed by the current stack separation unit; in the process of conveying parcels by an inclined conveyor belt, the inclined conveyor belt suddenly accelerates and then suddenly decelerates, and sudden acceleration changes and the inertia between two vertically stacked parcels (the parcels in a stacked state) result in that misalignment is caused between the two vertically stacked parcels; and then the visual identification system of the previous stack separation unit identifies the misalignment of the parcels according to overlapping conditions of the parcels conveyed by the current stack separation unit, a maximum speed of the inclined conveyor belt of the next stack separation unit is controlled to further separate the vertically stacked parcels at a larger acceleration required so as to guarantee the effective separation of the vertically stacked parcels, and when the vertically stacked parcels are separated, no change in the speed of the inclined conveyor belt is made, thereby reducing the damage to the inclined conveyor belt from sudden acceleration and saving a certain amount of energy.
3. For the multi-channel sorting machine for parcel singulation, when the parcels are still stacked, the maximum speed Vi+1 of the inclined conveyor belt is controlled to change; according to the calculated parcel stacking difference ratio Xi+1 of the current (the i+1^{th}) stack separation unit, a misalignment degree between two vertically stacked parcels in the previous (the i^{th}) stack separation unit may be obtained; when the misalignment degree is greater than 0.5, the maximum speed Vi+1 of the current inclined conveyor belt is equal to Vi, that is, the maximum speed remains unchanged, and when the maximum speed is consistent with a preset value of the previous stack separation unit, the misalignment degree of the current stack separation unit is also greater than 0.5, such that the two vertically stacked parcels in the current stack separation unit may be completely separated; and when the misalignment degree is less than 0.5, the maximum speed Vi+1 of the inclined conveyor belt in the i+1^{th} stack separation unit is 1.2 Vi, that is, an acceleration of the inclined conveyor belt in the i+1^{th} stack separation unit is increased, such that a force applied to the two vertically stacked parcels relatively increases, which enables more effective separation of the two vertically stacked parcels and effectively ensures the separation of the stacked parcels in the stack separation unit.

### DESCRIPTION OF THE DRAWINGS

FIG. 1 is a schematic diagram I of a three-dimensional structure of a multi-channel sorting machine for parcel singulation of the present disclosure;

FIG. 2 is an enlarged view of a portion A in FIG. 1 of the present disclosure;

FIG. 3 is a schematic diagram II of a three-dimensional structure of a multi-channel sorting machine for parcel singulation of the present disclosure;

FIG. 4 is a schematic diagram I of a three-dimensional structure of a multi-channel stack separation mechanism of the present disclosure;

FIG. 5 is a schematic diagram II of a three-dimensional structure of a multi-channel stack separation mechanism of the present disclosure;

FIG. 6 is a schematic diagram of a three-dimensional structure of a stack separation unit of the present disclosure;

FIG. 7 is a schematic diagram of a three-dimensional structure of an inclined conveyor belt of the present disclosure;

FIG. 8 is a schematic diagram I of a three-dimensional structure of a multi-channel parcel singulation mechanism of the present disclosure;

FIG. 9 is a schematic diagram II of a three-dimensional structure of a multi-channel parcel singulation mechanism of the present disclosure;

FIG. 10 is a schematic diagram of a three-dimensional structure of a parcel singulation unit of the present disclosure.

Reference numerals in the figures: 1—multi-channel stack separation mechanism; 11—stack separation unit; 111—inclined conveyor belt; 112—horizontal conveyor belt; 113—visual identification system; 12—transfer unit; 2—multi—channel parcel singulation mechanism; 21—parcel singulation unit; 211—transmission belt; 212—side guard plate; 213—drive roller; 214—timing pulley; 215—synchronous belt; and 22—single—parcel visual system.

### EMBODIMENTS OF THE INVENTION

The technical solutions in the embodiments of the present disclosure will be clearly and completely described below in combination with the accompanying drawings in the embodiments of the present disclosure. Apparently, the embodiments described are merely some rather than all of the embodiments of the present disclosure. Based on the embodiments of the present disclosure, all other embodiments obtained by those of ordinary skill in the art without making creative efforts shall fall within the protection scope of the present disclosure.

As introduced in the background art, there are deficiencies in the prior art, and in order to solve the above technical problems, the present disclosure provides a multi-channel sorting machine for parcel singulation.

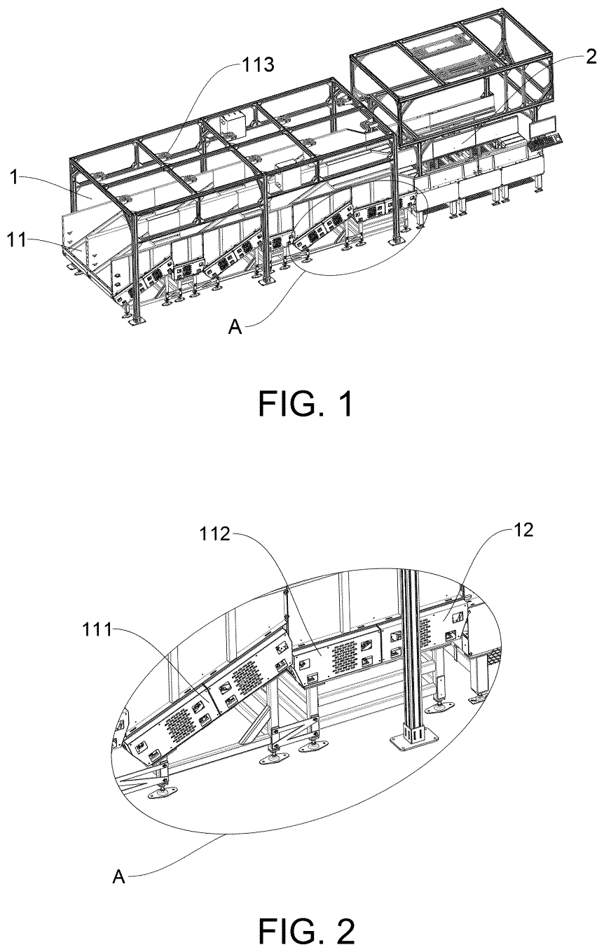

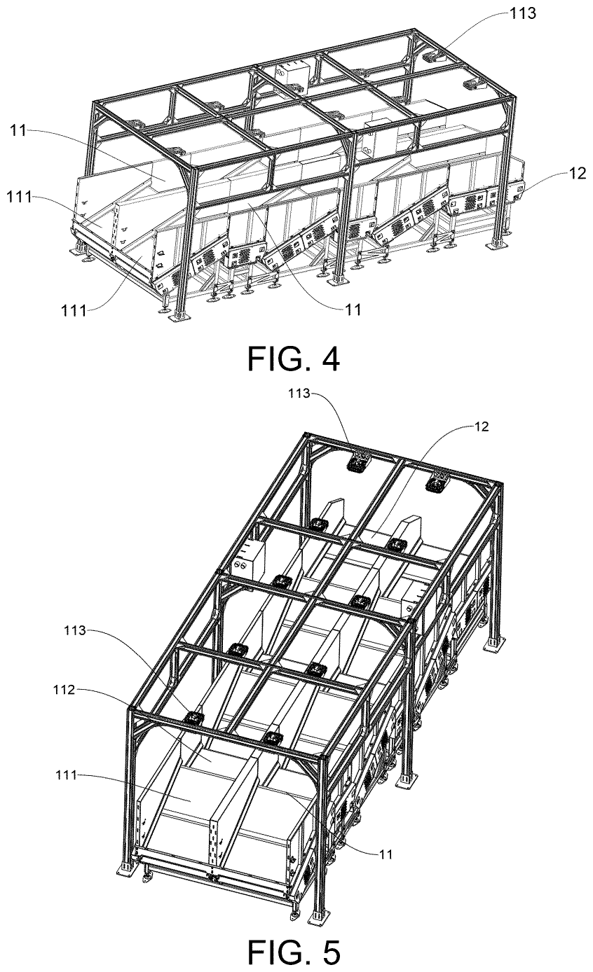

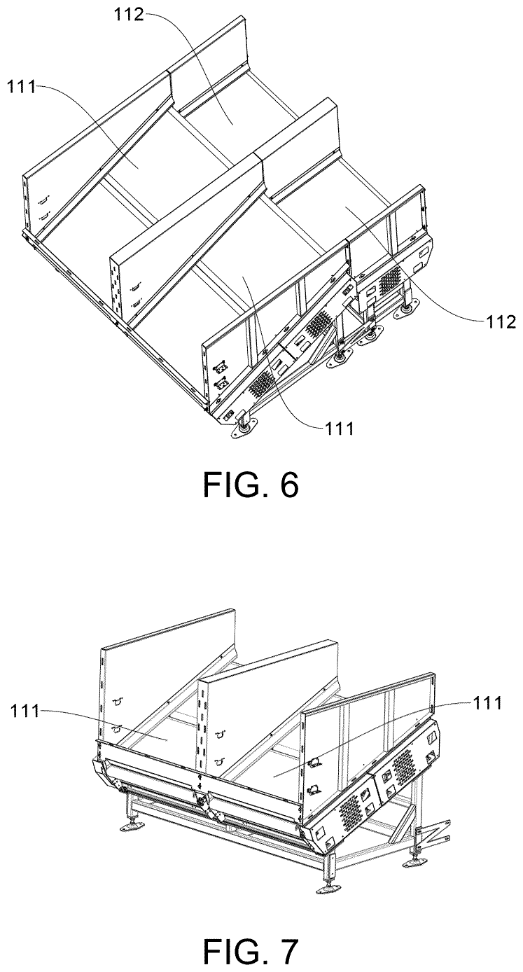

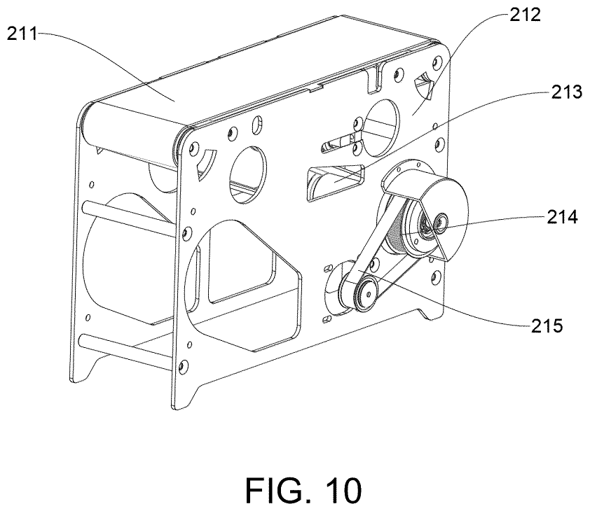

With reference to FIGS. 1 to 10, a multi-channel sorting machine for parcel singulation includes: a feeding mechanism, parcel separation channels, a roller centering machine, and a dragsaw belt conveyor; parcels are fed into the parcel separation channels through the feeding mechanism for separation, then centered, corrected, and aligned by the roller centering machine, and finally fed onto the dragsaw belt conveyor for conveying at a certain spacing therebetween; the number of the parcel separation channels is at least two, all the parcel separation channels are arranged side by side, and a partition is disposed between every two adjacent parcel separation channels; widths of the feeding mechanism, the roller centering machine, and the dragsaw belt conveyor are all adapted to a total width of all the parcel separation channels arranged side by side; each of the parcel separation channels includes a multi-channel stack separation mechanism 1 and a multi-channel parcel singulation mechanism 2, each of the multi-channel stack separation mechanisms 1 includes a plurality of stack separation channels, each of the multi-channel parcel singulation mechanisms 2 includes a plurality of parcel singulation channels, and for each of the parcel separation channels, the number of the stack separation channels is equal to the number of the parcel singulation channels; each of the stack separation channels includes a plurality of stack separation units 11 and a transfer unit 12, the plurality of the stack separation units 11 are connected end to end sequentially, and the transfer unit 12 is configured to transfer the parcels conveyed from the last stack separation unit 11 to the parcel singulation channel corresponding to the stack separation channel; each of the stack separation units 11 includes an inclined conveyor belt 111, a horizontal conveyor belt 112, and a visual identification system 113; and the visual identification system 113 identifies whether parcels overlap with each other, and the visual identification system 113 of the previous stack separation unit 11 controls a maximum speed of the inclined conveyor belt 111 of the next stack separation unit 11 according to overlapping conditions of the parcels conveyed by the current stack separation unit 11.

In use, a modular design is employed for all the feeding mechanism, the parcel separation channels, the roller centering machine, and the dragsaw belt conveyor, where the roller centering machine and the dragsaw belt conveyor are the same-named roller centering machine and the dragsaw belt conveyor of a fully-automated feeding system for a cross-belt sorting system in the prior patent application No. CN202111663821.X, and specific structures and operational principles of the roller centering machine and the dragsaw belt conveyor will not be described in detail here; in practical implementation, different numbers of the feeding mechanisms, the parcel separation channels, the roller centering machines, and the dragsaw belt conveyors may be combined according to actual needs of parcel sorting and classification to complete the conveying, classification, and separation of parcels; in the embodiments, one feeding mechanism, one parcel separation channel, one roller centering machine, and one dragsaw belt conveyor are preferably arranged and combined sequentially, and parcels are respectively conveyed to interiors of two parcel separation channels arranged side by side and separated by a partition through the feeding mechanism according to their conveying positions, where in each of the parcel separation channels, the parcels first pass through the multi-channel stack separation mechanism 1, and since the multi-channel stack separation mechanism includes a plurality of the stack separation channels, such that the parcels are respectively conveyed into each of the stack separation channels still in a conveying direction of the conveyor belt; in each of the stack separation channels, the parcels sequentially pass through a plurality of the stack separation units 11 connected end to end sequentially, and after separation, the overlapped parcels are fed into the transfer unit 12 for transfer to the corresponding parcel singulation channel in the multi-channel parcel singulation mechanism 2 corresponding to the stack separation channel, then screened and separated by the parcel singulation channel, and finally fed onto the dragsaw belt conveyor for output at a certain spacing therebetween after being centered, corrected, and aligned by the roller centering machine, so as to complete the parcel sorting operation; different numbers of the feeding mechanisms, the parcel separation channels, the roller centering machines, and the dragsaw belt conveyors are combined, and a plurality of channels are arranged in the parcel separation channels to meet multi-purpose requirements, and the multi-channel design reduces idle areas on both sides of each of the channels, improves the utilization efficiency of an equivalent area, and effectively improves the parcel processing efficiency of the entire multi-channel sorting machine for parcel singulation;
in each of the stack separation units 11, parcels first enter the inclined conveyor belt 111, and in the process of conveying by the inclined conveyor belt 111, the visual identification system 113 identifies whether parcels overlap with each other, and the visual identification system 113 of the previous stack separation unit 11 controls a maximum speed of the inclined conveyor belt 111 of the next stack separation unit 11 according to overlapping conditions of the parcels conveyed by the current stack separation unit 11; in the process of conveying parcels by an inclined conveyor belt 111, the inclined conveyor belt 111 suddenly accelerates and then suddenly decelerates, and sudden acceleration changes and the inertia between two vertically stacked parcels (the parcels in a stacked state) result in that misalignment is caused between the two vertically stacked parcels; and then the visual identification system 113 of the previous stack separation unit 11 identifies the misalignment of the parcels according to overlapping conditions of the parcels conveyed by the current stack separation unit 11, a maximum speed of the inclined conveyor belt 111 of the next stack separation unit 11 is controlled to further separate the vertically stacked parcels at a larger acceleration required so as to guarantee the effective separation of the vertically stacked parcels, and when the vertically stacked parcels are separated, no change in the speed of the inclined conveyor belt 111 is made, thereby reducing the damage to the inclined conveyor belt 111 from sudden acceleration and saving a certain amount of energy.

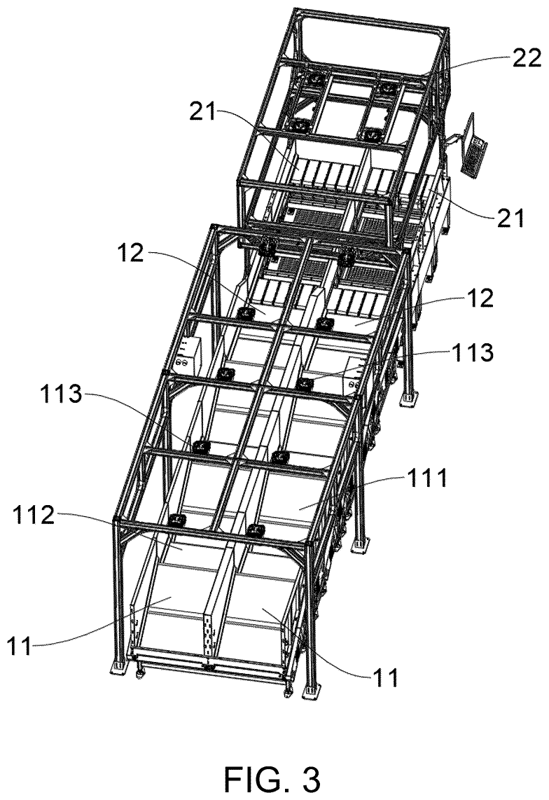

Further, with reference to FIGS. 3 to 7, in the i^{th} stack separation unit 11, the inclined conveyor belt 111 has an initial speed of V0, and the inclined conveyor belt 111 has a maximum speed of Vi; and the speed of the inclined conveyor belt 111 suddenly accelerates from V0 to Vi, and then suddenly decelerates from Vi to V0, to separate the stacked parcels conveyed in the i^{th} stack separation unit 11, such that by suddenly accelerating the speed of the inclined conveyor belt 111 from V0 to Vi and then suddenly decelerating from Vi to V0 in a short time, acceleration is achieved to separate the vertically stacked parcels by means of the inertia between the vertically stacked parcels.

Further, with reference to FIGS. 3 to 7, when the speed of the inclined conveyor belt 111 in the i^{th} stack separation unit 11 is V0, the visual identification system 113 identifies an area of parcels on a conveying surface of the current inclined conveyor belt 111, and calculates a percentage Wi % of the area of parcels to an area of the conveying surface of the inclined conveyor belt 111; and Wi of the parcels conveyed by the i^{th} stack separation unit 11 is compared with Wi+1 of the parcels conveyed by the i+1^{th} stack separation unit 11 to determine a stacking status of the parcels conveyed by the i+1^{th} stack separation unit 11.

When Wi+1=2 Wi, it is determined that parcels are stacked in the i^{th} stack separation unit 11, but the stacked parcels are completely separated in the i+1^{th} stack separation unit 11; when Wi+1=Wi, it is determined that no parcels are stacked in the i^{th} stack separation unit 11; and when Wi<Wi+1<2 Wi, it is determined that parcels are stacked in the i^{th} stack separation unit 11, and the stacked parcels are still stacked in the i+1^{th} stack separation unit 11.

When Wi+1=2 Wi and Wi+1=Wi, that is, when no parcels are stacked in the i+1^{th} stack separation unit 11, a maximum speed Vi+1 of the inclined conveyor belt 111 in the i+1^{th} stack separation unit 11 is equal to Vi.

When Wi<Wi+1<2 Wi, that is, when parcels are stacked in the i^{th} stack separation unit 11 and the stacked parcels are still stacked in the i+1^{th} stack separation unit 11: The maximum speed Vi+1 of the inclined conveyor belt 111 in the i+1^{th} stack separation unit In use, the visual identification system 113 of the previous (the i^{th}) stack separation unit 11 and the visual identification system 113 of the current (the i+1^{th}) stack separation unit 11 identify a percentage of the area of parcels to the area of the conveying surface of the inclined conveyor belt 111, and compare Wi of the parcels conveyed by the i^{th} stack separation unit 11 with Wi+1 of the parcels conveyed by the i+1^{th} stack separation unit 11, where when Wi+1=2 Wi, it is determined that parcels are stacked in the i^{th} stack separation unit 11, but the stacked parcels are completely separated in the i+1^{th} stack separation unit 11; when Wi+1=Wi, it is determined that no parcels are stacked in the i^{th} stack separation unit 11; and when Wi<Wi+1<2 Wi, it is determined that parcels are stacked in the i^{th} stack separation unit 11, and the stacked parcels are still stacked in the i+1^{th} stack separation unit 11, such that the maximum speed Vi+1 of the inclined conveyor belt 111 of the parcels in the current (the i+1^{th})stack separation unit 11 is adjusted according to parcel status changes, and when the parcels are still stacked, the maximum speed Vi+1 of the inclined conveyor belt 111 is controlled to change, so as to fully separate the vertically stacked parcels in the current stack separation unit 11.

Further, when Wi<Wi+1<2 Wi, that is, when parcels are stacked in the i^{th} stack separation unit 11 and the stacked parcels are still stacked in the i+1^{th} stack separation unit 11: A parcel stacking difference ratio Xi+1 between the i+1^{th} stack separation unit 11 and the i^{th} stack separation unit 11 is calculated, where Xi+1=(Wi+1−Wi)/W1; when Xi+1≥0.5, the maximum speed Vi+1 of the inclined conveyor belt 111 in the i+1^{th} stack separation unit 11 is equal to Vi; and when Xi+1<0.5, the maximum speed Vi+1 of the inclined conveyor belt 111 in the i+1^{th} stack separation unit 11 is equal to 1.2 Vi.

According to the calculated parcel stacking difference ratio Xi+1 of the current (the i+1^{th}) stack separation unit 11, a misalignment degree between two vertically stacked parcels in the previous (the i^{th}) stack separation unit 11 may be obtained; when the misalignment degree is greater than 0.5, the maximum speed Vi+1 of the current inclined conveyor belt 111 is equal to Vi, that is, the maximum speed remains unchanged, and when the maximum speed is consistent with a preset value of the previous stack separation unit 11, the misalignment degree of the current stack separation unit 11 is also greater than 0.5, such that the two vertically stacked parcels in the current stack separation unit 11 may be completely separated; and when the misalignment degree is less than 0.5, the maximum speed Vi+1 of the inclined conveyor belt 111 in the i+1^{th} stack separation unit 11 is 1.2 Vi, that is, an acceleration of the inclined conveyor belt 111 in the i+1^{th} stack separation unit 11 is increased, such that a force applied to the two vertically stacked parcels relatively increases, which enables more effective separation of the two vertically stacked parcels and effectively ensures the separation of the stacked parcels in the stack separation unit 11.

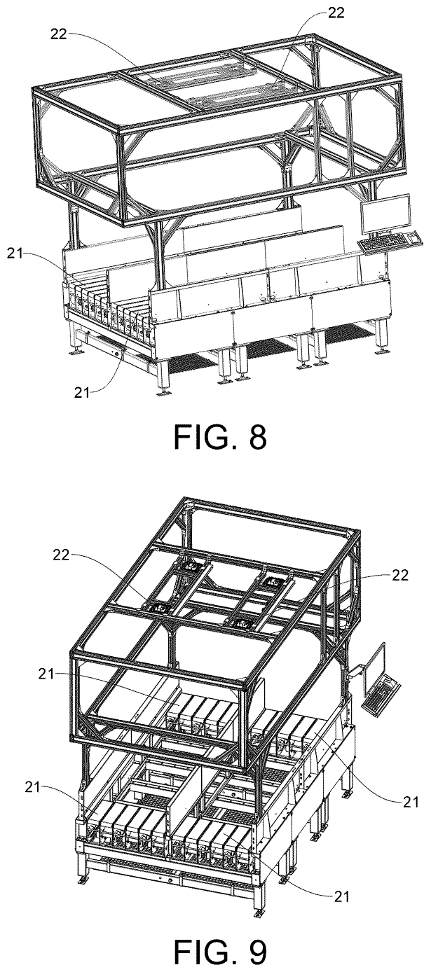

Further, with reference to FIGS. 8 to 10, each of the parcel singulation channels includes a plurality of parcel singulation units 21 and a single-parcel visual system 22, where a conveying speed of each of the parcel singulation units 21 may be set separately, and the single-parcel visual system 22 is configured to identify parcel classification information and control the conveying speed of each of the parcel singulation units 21 respectively, so as to arrange the parcels in an orderly manner.

Each of the parcel singulation units 21 includes a transmission belt 211, side guard plates 212, a drive roller 213, a timing pulley 214, and a synchronous belt 215; and the side guard plates 212 are disposed on both sides of the transmission belt 211, a servo motor is disposed in either of the two side guard plates 212, an output shaft of the servo motor outputs power to the timing pulley 214 through the synchronous belt 215, rotation of the timing pulley 214 is transmitted to the drive roller 213 coaxial with the timing pulley 214, and the drive roller 213 drives the transmission belt 211 to rotate.

In each of the parcel singulation channels, the single-parcel visual system 22 identifies the parcel classification information, and then a background control terminal controls an output rotational speed of the servo motor of each of the parcel singulation units 21, such that the output shaft of the servo motor outputs power to the timing pulley 214 through the synchronous belt 215, the rotation of the timing pulley 214 is transmitted to the drive roller 213 coaxial with the timing pulley 214, and the drive roller 213 drives the transmission belt 211 to rotate, so as to adjust a conveying speed of the transmission belt 211 of each of the parcel singulation units 21, adjust a conveying position of each parcel, and convey the parcels after arranging in an orderly manner.

Operational principle: Parcels are respectively conveyed to interiors of two parcel separation channels arranged side by side and separated by a partition through the feeding mechanism according to their conveying positions, where in each of the parcel separation channels, the parcels first pass through the multi-channel stack separation mechanism 1, and since the multi-channel stack separation mechanism includes a plurality of the stack separation channels, such that the parcels are respectively conveyed into each of the stack separation channels still in a conveying direction of the conveyor belt; in each of the stack separation channels, the parcels sequentially pass through a plurality of the stack separation units 11 connected end to end sequentially;

in each of the stack separation units 11, parcels first enter the inclined conveyor belt 111, and in the process of conveying by the inclined conveyor belt 111, the visual identification system 113 identifies whether parcels overlap with each other, and the visual identification system 113 of the previous stack separation unit 11 controls a maximum speed of the inclined conveyor belt 111 of the next stack separation unit 11 according to overlapping conditions of the parcels conveyed by the current stack separation unit 11; in the process of conveying parcels by an inclined conveyor belt 111, the inclined conveyor belt 111 suddenly accelerates and then suddenly decelerates, and sudden acceleration changes and the inertia between two vertically stacked parcels (the parcels in a stacked state) result in that misalignment is caused between the two vertically stacked parcels; and then the visual identification system 113 of the previous stack separation unit 11 identifies the misalignment of the parcels according to overlapping conditions of the parcels conveyed by the current stack separation unit 11, a maximum speed of the inclined conveyor belt 111 of the next stack separation unit 11 is controlled to further separate the vertically stacked parcels at a larger acceleration required so as to guarantee the effective separation of the vertically stacked parcels, and when the vertically stacked parcels are separated, no change in the speed of the inclined conveyor belt 111 is made, thereby reducing the damage to the inclined conveyor belt 111 from sudden acceleration and saving a certain amount of energy;

In each of the stack separation channels, the visual identification system 113 of the previous (the i^{th}) stack separation unit 11 and the visual identification system 113 of the current (the i+1^{th}) stack separation unit 11 identify a percentage of the area of parcels to the area of the conveying surface of the inclined conveyor belt 111, and compare Wi of the parcels conveyed by the i^{th} stack separation unit 11 with Wi+1 of the parcels conveyed by the i+1^{th} stack separation unit 11, where when Wi+1=2 Wi, it is determined that parcels are stacked in the i^{th} stack separation unit 11, but the stacked parcels are completely separated in the i+1^{th} stack separation unit 11; when Wi+1=Wi, it is determined that no parcels are stacked in the i^{th} stack separation unit 11, and the maximum speed Vi+1 of the inclined conveyor belt 111 in the i+1^{th} stack separation unit 11 is equal to Vi; and when Wi<Wi+1<2 Wi, it is determined that parcels are stacked in the i^{th} stack separation unit 11, and the stacked parcels are still stacked in the i+1^{th} stack separation unit 11, such that the maximum speed Vi+1 of the inclined conveyor belt 111 of the parcels in the current (the i+1^{th}) stack separation unit 11 is adjusted according to parcel status changes, and the maximum speed Vi+1 of the inclined conveyor belt 111 is greater than or equal to Vi;
when the parcels are still stacked, the maximum speed Vi+1 of the inclined conveyor belt 111 is controlled to change; according to the calculated parcel stacking difference ratio Xi+1 of the current (the i+1^{th}) stack separation unit 11, a misalignment degree between two vertically stacked parcels in the previous (the i^{th}) stack separation unit 11 may be obtained; when the misalignment degree is greater than 0.5, the maximum speed Vi+1 of the current inclined conveyor belt 111 is equal to Vi, that is, the maximum speed remains unchanged, and when the maximum speed is consistent with a preset value of the previous stack separation unit 11, the misalignment degree of the current stack separation unit 11 is also greater than 0.5, such that the two vertically stacked parcels in the current stack separation unit 11 may be completely separated; and when the misalignment degree is less than 0.5, the maximum speed Vi+1 of the inclined conveyor belt 111 in the i+1^{th} stack separation unit 11 is 1.2 Vi, that is, an acceleration of the inclined conveyor belt 111 in the i+1^{th} stack separation unit 11 is increased, such that a force applied to the two vertically stacked parcels relatively increases, which enables more effective separation of the two vertically stacked parcels and effectively ensures the separation of the stacked parcels in the stack separation unit 11;
after separation, the overlapped parcels are fed into the transfer unit 12 for transfer to the corresponding parcel singulation channel in the multi-channel parcel singulation mechanism 2 corresponding to the stack separation channel, in each of the parcel singulation channels, the single-parcel visual system 22 identifies the parcel classification information, and then a background control terminal controls an output rotational speed of the servo motor of each of the parcel singulation units 21, such that the output shaft of the servo motor outputs power to the timing pulley 214 through the synchronous belt 215, the rotation of the timing pulley 214 is transmitted to the drive roller 213 coaxial with the timing pulley 214, and the drive roller 213 drives the transmission belt 211 to rotate, so as to adjust a conveying speed of the transmission belt 211 of each of the parcel singulation units 21, adjust a conveying position of each parcel, and convey the parcels after arranging in an orderly manner;
the parcels are screened and separated by the parcel singulation channel, and finally fed onto the dragsaw belt conveyor for output at a certain spacing therebetween after being centered, corrected, and aligned by the roller centering machine, so as to complete the parcel sorting operation; different numbers of the feeding mechanisms, the parcel separation channels, the roller centering machines, and the dragsaw belt conveyors are combined, and a plurality of channels are arranged in the parcel separation channels to meet multi-purpose requirements, and the multi-channel design reduces idle areas on both sides of each of the channels, improves the utilization efficiency of an equivalent area, and effectively improves the parcel processing efficiency of the entire multi-channel sorting machine for parcel singulation.

Although the embodiments of the present disclosure have been illustrated and described, it should be understood that those of ordinary skill in the art may make various changes, modifications, replacements and variations to the above embodiments without departing from the principle and spirit of the present disclosure, and the scope of the present disclosure is limited by the appended claims and their legal equivalents.

1. A multi-channel sorting machine for parcel singulation, comprising:
a feeding mechanism, parcel separation channels, a roller centering machine and a dragsaw belt conveyor, parcels are fed into the parcel separation channels through the feeding mechanism for separation, then centered, corrected, and aligned by the roller centering machine, and finally fed onto the dragsaw belt conveyor for conveying at a certain spacing therebetween;
number of the parcel separation channels is at least two, all the parcel separation channels are arranged side by side, and a partition is disposed between every two adjacent parcel separation channels;
widths of the feeding mechanism, the roller centering machine, and the dragsaw belt conveyor are all adapted to a total width of all the parcel separation channels arranged side by side;
each of the parcel separation channels comprises a multi-channel stack separation mechanism and a multi-channel parcel singulation mechanism, each of the multi-channel stack separation mechanisms comprises a plurality of stack separation channels, each of the multi-channel parcel singulation mechanisms comprises a plurality of parcel singulation channels, and for each of the parcel separation channels, number of the stack separation channels is equal to number of the parcel singulation channels;
each of the stack separation channels comprises a plurality of stack separation units and a transfer unit, the plurality of the stack separation units are connected end to end sequentially, and the transfer unit is configured to transfer parcels conveyed from the last stack separation unit to the parcel singulation channel corresponding to the stack separation channel;
each of the stack separation units comprises an inclined conveyor belt, a horizontal conveyor belt and a visual identification system;
the visual identification system identifies whether parcels overlap with each other, and the visual identification system of the previous stack separation unit controls a maximum speed of the inclined conveyor belt of the next stack separation unit according to overlapping conditions of the parcels conveyed by the current stack separation unit;
in i^{th} stack separation unit, the inclined conveyor belt has an initial speed of V0, and the inclined conveyor belt has the maximum speed of Vi;
speed of the inclined conveyor belt suddenly accelerates from V0 to Vi, and then suddenly decelerates from Vi to V0, to separate the stacked parcels conveyed in the i^{th} stack separation unit;
when the speed of the inclined conveyor belt in the i^{th} stack separation unit is V0, the visual identification system identifies an area of parcels on a conveying surface of the current inclined conveyor belt, and calculates a percentage Wi % of the area of parcels to an area of the conveying surface of the inclined conveyor belt;
Wi of the parcels conveyed by the i^{th} stack separation unit is compared with Wi+1 of the parcels conveyed by the i+1^{th} stack separation unit to determine a stacking status of the parcels conveyed by the i+1^{th} stack separation unit;
when Wi+1=2 Wi, the visual identification system is determined that parcels are stacked in the i^{th} stack separation unit, but the stacked parcels are completely separated in the i+1^{th} stack separation unit;
when Wi+1=Wi, the visual identification system is determined that no parcels are stacked in the i^{th} stack separation unit;
when Wi<Wi+1<2 Wi, the visual identification system is determined that parcels are stacked in the i^{th} stack separation unit, and the stacked parcels are still stacked in the i+1^{th} stack separation unit;
when Wi+1=2 Wi and Wi+1=Wi, that is, when no parcels are stacked in the i+1^{th} stack separation unit, a maximum speed Vi+1 of the inclined conveyor belt in the i+1^{th} stack separation unit is equal to Vi;
when Wi<Wi+1<2 Wi, the visual identification system is determined that parcels are stacked in the i^{th} stack separation unit, and the stacked parcels are still stacked in the i+1^{th} stack separation unit; and
the maximum speed Vi+1 of the inclined conveyor belt in the i+1^{th} stack separation unit is greater than or equal to Vi.

2. The multi-channel sorting machine for parcel singulation according to claim 1, wherein when Wi<Wi+1<2 Wi, that is, when parcels are stacked in the i^{th} stack separation unit and the stacked parcels are still stacked in the i+1^{th} stack separation unit:
a parcel stacking difference ratio Xi+1 between the i+1^{th} stack separation unit and the i^{th} stack separation unit is calculated, wherein Xi+1=(Wi+1−Wi)]]/W1;
when Xi+1>0.5, the maximum speed Vi+1 of the inclined conveyor belt in the i+1^{th} stack separation unit is equal to Vi; and
when Xi+1<0.5, the maximum speed Vi+1 of the inclined conveyor belt in the i+1^{th} stack separation unit is equal to 1.2 Vi.

3. The multi-channel sorting machine for parcel singulation according to claim 1, that: wherein each of the parcel singulation channels comprises a plurality of parcel singulation units and a single-parcel visual system, wherein a conveying speed of each of the parcel singulation units is set separately, and the single-parcel visual system is configured to identify parcel classification information and control the conveying speed of each of the parcel singulation units respectively, so as to arrange the parcels in an orderly manner.

4. The multi-channel sorting machine for parcel singulation according to claim 3, that: wherein each of the parcel singulation units comprises a transmission belt, side guard plates, a drive roller, a timing pulley and a synchronous belt; and
the side guard plates are disposed on both sides of the transmission belt, a servo motor is disposed in either of the two side guard plates, an output shaft of the servo motor outputs power to the timing pulley through the synchronous belt, rotation of the timing pulley is transmitted to the drive roller coaxial with the timing pulley, and the drive roller drives the transmission belt to rotate.
